(19) United States
(12) Patent Application Publication
(10) Pub. No.: US 2021/0039542 A1
(43) Pub. Date: Feb. 11, 2021

(54) BED RAMP EXTENDER

(71) Applicant: Ernest S. White, Paris, TX (US)

(72) Inventor: Ernest S. White, Paris, TX (US)

(21) Appl. No.: 16/532,795

(22) Filed: Aug. 6, 2019

(51) Int. Cl. B60P 1/43

(52) U.S. Cl. CPC B60P 1/435

(57) ABSTRACT

Embodiments of the present invention provides a system and method of a collapsible ramp which includes a plurality of planar members, a plurality of dual hinges, and plurality of hinges. In one embodiment, the collapsible ramp is configured to collapse in a zig-zag pattern. In an alternative embodiment, the collapsible ramp is configured to collapse in a coil pattern. In one embodiment, the collapsible ramp is connected to a tailgate of a pickup truck. In another embodiment, the collapsible ramp is connected to a cabinet door assembly that is removable from a tailgate of a pickup truck.

### BACKGROUND

### 1. Field of the Invention

The present application relates to the field of ramp systems, and more particularly to integrated truck ramps.

### 2. Description of Related Art

Cargo moving vehicles generally have loading ramps that allow a user to load cargo easily on and off the vehicle. Ramps are positioned at an inclined gradient that spreads out the necessary work over a greater distance, thus allowing a user to raise a heavy object a vertical distance by also traversing horizontal distance. Moving trucks and trailers often have a compartment beneath a storage platform of the truck or trailer that stores a sliding ramp. When transferring cargo off the truck or trailer, the user slides the ramp out of the compartment and places one end of the ramp on the ground and another end of the ramp at the end of the storage platform. For some ramp configurations, the ramp can be securely mounted to the truck or trailer by hooking the ramp to the end of the storage platform through a hook mounted on one end of the ramp and a matting aperture located along the ledge of the storage platform that is configured to the hook. However, this configuration has several drawbacks. Typically the ramp is a single body that can have considerable length, thus either the ramp must be stored at a respective destination to load or unload the cargo, or the vehicle transporting the cargo must have accommodating compartment space to store the ramp during transit. While this is a trivial problem for large commercial vehicles that have ample storage solutions, pickup trucks have limited space to carry cargo, thus forcing a pickup truck owner to seek alternative solutions for transporting a ramp or other means to unload cargo.

A system is needed for a collapsible ramp that permits for compact storage on a pickup truck. Although strides have been made to improve ramp capabilities for pickup trucks, considerable shortcomings remain.

### SUMMARY OF THE INVENTION

Embodiments of the present invention disclose a method and system of a collapsible bed ramp for a pickup truck. In one embodiment of the present invention, a system is provided comprising: a plurality of planar members; an intermediate planar member; a first dual hinge that permits an angular range of 90 degrees; a second dual hinge that permits an angular range of 180 degrees; and a plurality of a third hinge that permits an angular range of 180 degrees. In one embodiment, the ramp system is configured to permit a zig-zag collapsing pattern. In another embodiment, the ramp system is configured to permit a coil collapsing pattern. In one embodiment, the collapsible ramp is connected to a tailgate of a pickup truck. In another embodiment, the collapsible ramp is connected to a cabinet door assembly that is removable from a tailgate of a pickup truck.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a first ramp system demonstrating a range of motion, in accordance with an embodiment of the present invention;

FIG. 2 is a side view of the first ramp system in an extended position, in accordance with an embodiment of the present invention;

FIG. 3 is a side view of the first ramp system in a storage position, in accordance with an embodiment of the present invention;

FIG. 4 is a side view of the first ramp system expanding from the storage position to a first position, in accordance with an embodiment of the present invention;

FIG. 5 is a side view of the first ramp system expanding from the first position to a second position that allows the first ramp system to expand into the extended position, in accordance with an embodiment of the present invention;

FIG. 6 is a perspective view of the first ramp system having a hinge locking mechanism while in a disengaged state, in accordance with an embodiment of the present invention;

FIG. 7 is a perspective view of the first ramp system in the extended position while having the hinge locking mechanism engaged, in accordance with an embodiment of the present invention;

FIG. 8 is a side view of a second ramp system demonstrating a range of motion, in accordance with an embodiment of the present invention;

FIG. 9 is a side view of the second ramp system in an extended position, in accordance with an embodiment of the present invention;

FIG. 10 is a side view of the second ramp system demonstrating a coil configuration, in accordance with an embodiment of the present invention;

FIG. 11 is a side view of the second ramp system in a storage position, in accordance with an embodiment of the present invention;

FIG. 12 is a side view of the second ramp system expanding from the storage position to a first position that allows the second ramp system to expand into the extended position, in accordance with an embodiment of the present invention; and

FIG. 13 are assorted views of a storage cabinet that houses a ramp system.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The system and method in accordance with the present invention overcomes one or more of the above-discussed problems commonly associated with traditional ramp systems. In particular, the system of the present invention is a collapsible ramp that is mounted to a tailgate of a pickup truck, thus permitting compact storage of the ramp for loading and unloading cargo from the bed of the truck. The system is composed of a plurality of planar members interconnected to each other by a corresponding plurality of hinges. When configured into an extended position, the ramp system is capable of supporting a load being transported from a ground foundation to a truck bed. The plurality of planar members fold into a storage configuration via the plurality of hinges, wherein the storage configuration is dependent on various embodiments of the ramp system further discussed below. An advantage of this system is the portability and reduction of space required to store the ramp system on a pickup truck. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

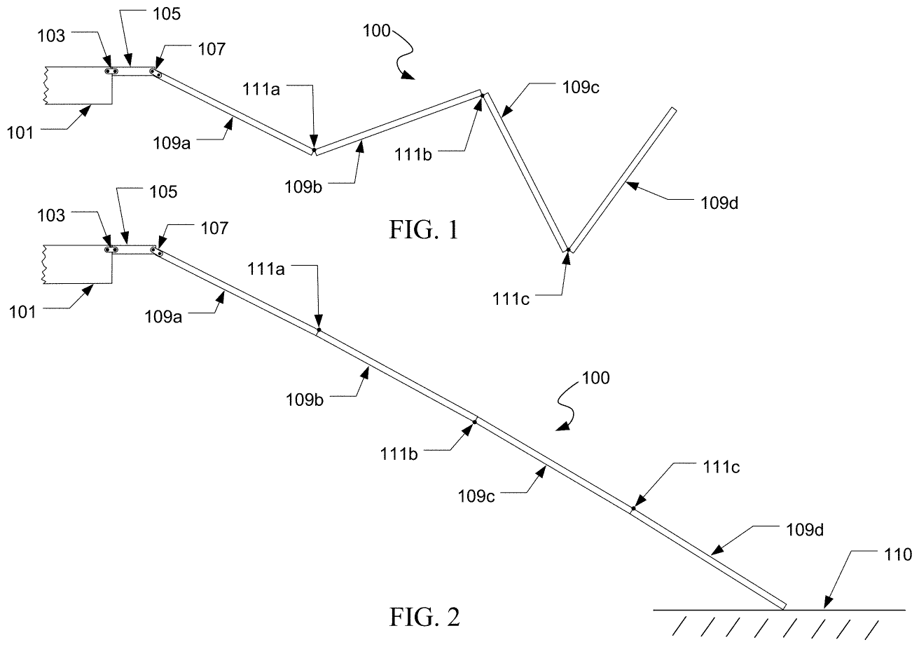

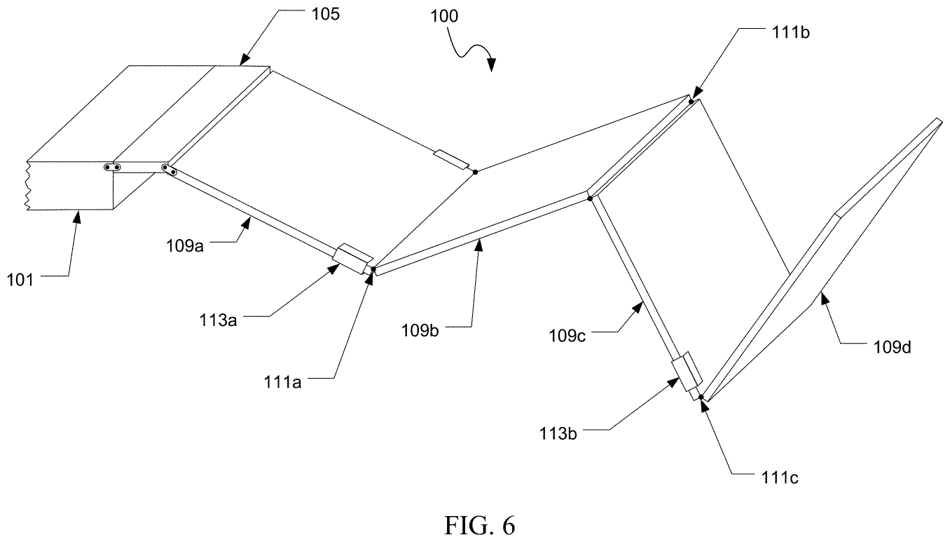

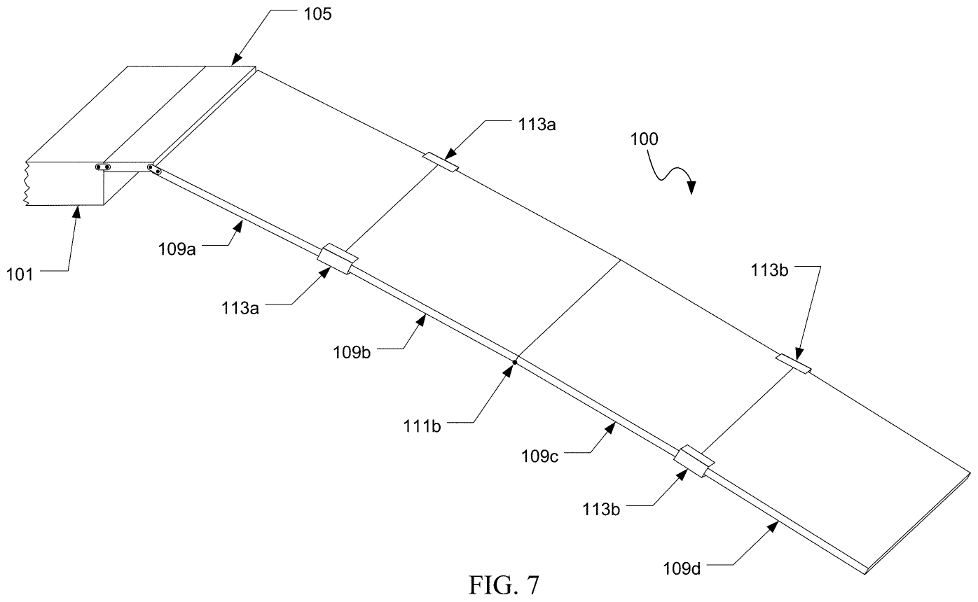

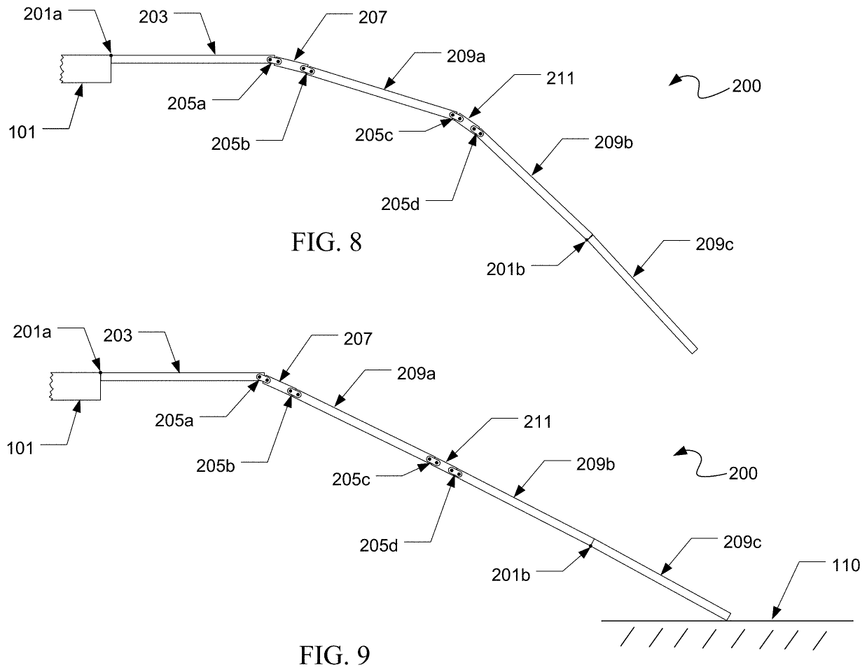

Referring now to the drawings wherein like reference characters identify corresponding or similar elements in form and function throughout the several views. FIGS. 1-5 illustrate assorted views and elements of ramp system 100. FIGS. 6-7 illustrate a locking mechanism for ramp system 100. FIGS. 8-12 illustrate assorted views and elements of ramp system 200. FIG. 13 illustrates assorted views of a storage cabinet that houses either ramp system 100 or ramp system 200. Ramp system 100 and ramp system 200 are configured to include a plurality of planar members that support structural load in conjunction with a plurality of hinges, wherein the difference between ramp system 100 and ramp system 200 is a storage configuration based on a configuration of the plurality of hinges.

Referring now to FIGS. 1-5, an embodiment of ramp system 100 is depicted in various positions.

In FIG. 1, a side view of a first ramp system is depicted demonstrating a range of motion. In this figure, ramp system 100 comprises a plurality of planar members 109a-d, intermediate planar member 105, a dual hinge that permits an angular range of at least 90 degrees (i.e., hinge 103), a dual hinge that permits an angular range of at least 180 degrees (i.e., hinge 107), and a plurality of hinges 111a-c that each permits an angular range of at least 180 degrees. In this embodiment, ramp system 100 is integrated with a pickup truck by a hinge mounting between tailgate 101 and intermediate planar member 105 via hinge 103.

FIG. 2 illustrates a side view of ramp system 100 in an extended position. During the extended position, ramp system 100 forms a ramp between tailgate 101 and ground 110, thus allowing a user to utilize ramp system 100 as a ramp in moving cargo from ground 110 into a truck bed via tailgate 101. The plurality of planar members 109a-d and intermediate planar member 105 in conjunction with the plurality of hinges transfer structural loads to ground 110 and tailgate 101.

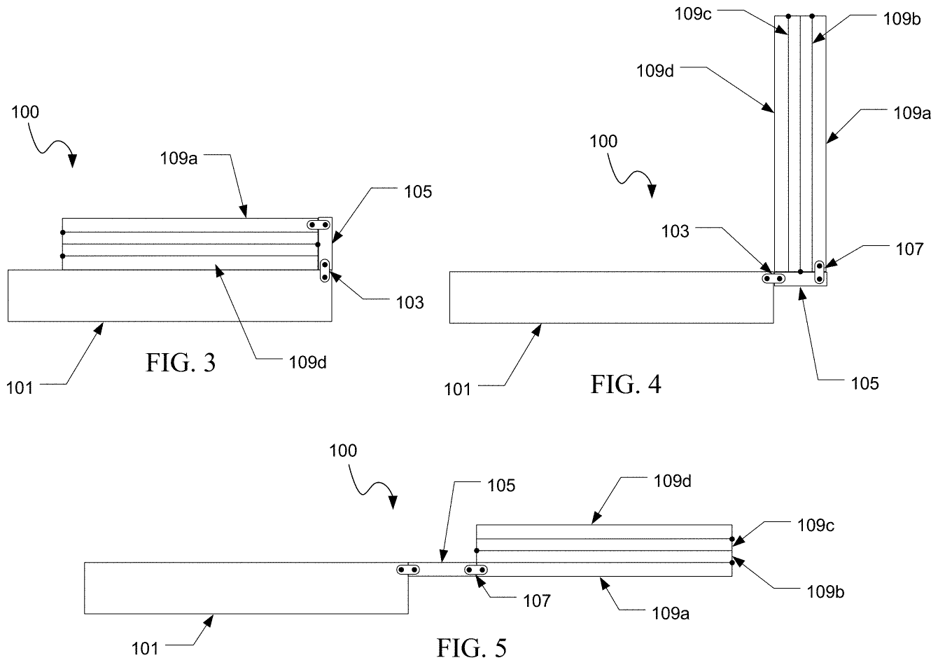

FIG. 3 illustrates a side view of ramp system 100 in a storage position. During the storage position, ramp system 100 is in a compact configuration thus permitting ramp system 100 to be easily transported while attached to tailgate 101.

FIG. 4 illustrates a side view of ramp system 100 expanding from the storage position to a first position in a process of expanding ramp system 100 to an extended position. In this figure, ramp system 100 pivots via hinge 103 with respect to tailgate 101. Intermediate planar member 107 structurally supports a load of the plurality of planar members 109a-d by transferring the load to tailgate 101 via hinge 103.

FIG. 5 illustrates a side view of ramp system 100 expanding from the first position to a second position that permits ramp system 100 to expand into the extended position. In this figure, a plurality of planar members 109a-d of ramp system 100 pivots via hinge 107 with respect to intermediate planar member 105 while intermediate planar member 105 remains parallel with tailgate 101.

Tailgate 101 is a conventional tailgate generally associated with pickup trucks. Hinge 103 is a dual hinge device comprising of two hinges and an intermediate member that connects the two hinges, wherein the two hinges are on opposing ends of the intermediate member. The intermediate member of hinge 103 pivots with respect to tailgate 101 based on a first hinge that connects tailgate 101 and the intermediate member of hinge 103. Furthermore, the intermediate member of hinge 103 pivots with respect to intermediate planar member 105 (also commonly referred to as member 105) based on a second hinge that connects intermediate planar member 105 and the intermediate member of hinge 103. The assembly between tailgate 101, hinge 103, and intermediate planar member 105 is such that the combined pivotal angle between tailgate 101 and intermediate planar member 105 is at least 90 degrees. For example, when system 100 is in a storage position (see FIG. 3), the angular range of motion of hinge 103 allows for intermediate planar member 105 to orient perpendicularly to a planar face of tailgate 101; and when system 100 is in an extended position (see FIG. 2), the angular range of motion of hinge 103 allows for intermediate planar member 105 to lay parallel with the planar face of tailgate 101, thus the total angular range of motion of hinge 103 is at least 90 degrees with respect to tailgate 101 and intermediate planar member 105. Various types of hinges that allow the at least 90 degrees of angular range of motion for hinge 103 are contemplated. In alternate embodiments, hinge 103 allows a full range of motion wherein the realized angular range of motion of the system is dependent on a geometrical configuration between tailgate 101 and member 105 that limit the angular range.

In a further embodiment, a raised node (not shown) integrated with tailgate 101 that splays away from the planar face of tailgate 101 can serve as an attachment point for hinge 103 and tailgate 103. In this embodiment, when system 100 is in an extended position, intermediate planar member 105 planarly mates with tailgate 101 such that tailgate 101 serves as a fulcrum between the tailgate 105 connection with hinge 103 and a load at an opposing end of intermediate planar member 105 (e.g., loads transferred via hinge 107 from planar member 109a and etc.)

Intermediate planar member 105 has hinge 103 attached to a first end of member 105, and hinge 107 attached to a second end of member 105. Hinge 107 is a dual hinge device comprising of two hinges and an intermediate member that connects the two hinges, wherein the two hinges are on opposing ends of the intermediate member. The intermediate member of hinge 107 pivots with respect to intermediate planar member 105 based on a first hinge that connects member 105 and the intermediate member of hinge 107. Furthermore, the intermediate member of hinge 107 pivots with respect to planar member 109a based on a second hinge that connects planar member 109a and the intermediate member of hinge 107. The assembly between member 105, hinge 107, and planar member 109a is such that the combined pivotal angle between member 105 and planar member 109a is at least 180 degrees. For example, when system 100 is in a storage position (see FIG. 3), the angular range of motion of hinge 107 allows for planar member 109a to orient perpendicularly to a planar face of member 105. Furthermore, hinge 107 allows for planar member 109a to pivot to an orientation that is perpendicular to an opposing planar face of member 105. Thus, the total angular range of motion of hinge 107 is at least 180 degrees with respect to member 105 and planar member 109a. This allows system 100 to assume variable ramp inclinations dependent on the height of tailgate 101 with respect to the ground. Various types of hinges that allow the at least 180 degrees of angular range of motion for hinge 107 are contemplated. In alternate embodiments, hinge 107 allows a full range of motion wherein the realized angular range of motion of the system is dependent on a geometrical configuration between member 105 and planar member 107 that limit the angular range.

Intermediate planar member 105 has a length corresponding to a combined height of planarly stacked planar members. For example, see FIG. 3 wherein member 105 has a corresponding height that permits member 105 and planar member 109a to form a right angle respective to each other while simultaneously containing a remainder of planar members planarly stacked between planar member 109a and tailgate 101.

In one embodiment, a plurality of planar members and a plurality of hinges are interconnected and configured to form a ramp, wherein the configuration allows for the ramp assembly to collapse in a “zig-zag” pattern, such as what is shown in FIG. 1. For example, the plurality of planar members 109a-d are interconnected by a plurality of hinges 111a-c. In this example, planar member 109a and planar member 109b are interconnected via hinge 111a, planar member 109b and planar member 109c are interconnected via hinge 111b, and planar member 109c and planar member 109d are interconnect via hinge 111c. In one embodiment, Hinges 111a-c are placed in an alternating configuration along the assembly of planar members 109a-d such that hinges 111a-c allow the assembly to fold in a zig-zag configuration. Hinges 111a-c are configured to allow a 180 degree angular motion. In an alternate embodiment, a range of angular motion of hinges 111a-c is limited by mating geometry of respective planar members. For example, in an extended position (FIG. 2), hinge 111a is positioned to allow member 109a and member 109b to pivot with respect to each other, but angular motion is limited by a mating of respective ends of member 109a and member 109b. Conversely, in a storage position (e.g., FIG. 4), hinge 111a allows member 109a and member 109b to planarly mate. Additionally, hinge 111a and/or the geometrical configuration between member 109a and member 109b permits member 109a and member 109b to pivot 180 degrees such that member 109a and member 109 are planarly in line and flush (e.g., FIG. 2).

Hinge 111c is of similar form and function as hinge 111a with respect to angular motion of planar member 109c and planar member 109d.

Hinge 111b is of similar form as hinge 111a and hinge 111c with respect to angular motion of planar member 109b and planar member 109c, however, hinge 111b is positioned to permit rotation opposite of that of hinge 111a and hinge 111c (thus permitting a zig-zag folding configuration). For example, hinge 111a permits a first planar face of member 109b to planarly mate with member 109a, hinge 111b permits a first planar face of member 109c to planarly mate with a second planar face of member 109b, and hinge 111c permits member 109d to planarly mate with a second planar face of member 109c.

While previously said embodiment describes a ramp system comprising of four planar members (i.e., planar members 109a-d), alternative embodiments using any number planar members are also contemplated, wherein the any number of planar members are interconnected using a corresponding plurality of hinges that permit a zig-zag collapsing configuration.

In one embodiment, planar members 109a-d may come in variable lengths. In another embodiment, planar members 109a-d have equal lengths. In a further embodiment, lengths of each planar member of planar members 109a-d may not exceed a length of tailgate 101. In this embodiment, the restricted length of planar members 109a-d permit tailgate 101 to be in closed position according to normal operation of a tailgate of a corresponding pickup truck. In an alternative embodiment, lengths of each planar member of planar members 109a-d may exceed a length of tailgate 101. In this embodiment, the lengths of planar members 109a-d prevent tailgate 101 to be in a closed position.

In this embodiment of ramp system 100, a user engages ramp system 100 from a storage position to an engaged position through the following steps:

Starting with tailgate 101 in a disengaged position (i.e., is parallel with the ground) and ramp system 100 in a storage position (FIG. 3), the user pivots ramp system 100 via hinge 103 with respect to tailgate 101, resulting in the configuration of FIG. 4.

The user pivots a plurality of planar members 109a-d of ramp system 100 via hinge 107 with respect to intermediate planar member 105 while intermediate planar member 105 remains parallel with tailgate 101, resulting in the configuration of FIG. 5.

The user unfolds the plurality of planar members 109a-d of ramp system 100 via a plurality of hinges 111a-c and hinge 107, resulting in the configuration of FIG. 1. During this phase, the plurality of hinges 111a-c and hinge 107 associated with the plurality of planar members 109a-d may operate at variable instances. Ramp system 100 may assume a variety of configurations during this phase that ultimately leads to the engaged configuration of FIG. 2.

The user straightens the plurality of planar members 109a-d of ramp system 100 via a plurality of hinges 111a-c and hinge 107, resulting in the configuration of FIG. 2. In this position, the user places a first end of planar member 109d in contact with ground 110 and configures the plurality of planar members 109a-d in a parallel and straight line.

Referring now to FIGS. 6-7, an embodiment of a hinge locking mechanism for ramp system 100 is depicted in various positions.

In FIG. 6, a perspective view of ramp system 100 having a hinge locking mechanism while in a disengaged state is depicted. In this embodiment, ramp system 100 is in a position of that of FIG. 4. As the embodiment of ramp system 100 currently stands, any gravitational load applied to planar member 109a and planar member 109b will cause hinge 111a to buckle towards the ground, and likewise any gravitational load applied to planar member 109c and planar member 109d will cause hinge 111c buckle toward the ground as well. Thus, a locking mechanism to secure hinge 111a and hinge 111c to prevent buckling is desired. In this embodiment, FIG. 6 depicts a set of locking mechanisms 113a and 113b that corresponds to hinges 111a and 111c. Locking mechanism 113a and locking mechanism 113b are a C-shaped member that are capable of encapsulating a corresponding hinge and corresponding portions of a plurality of planar members that are associated with the hinge. Placement of locking mechanism 113 and 113 over a corresponding hinge and portions of a plurality of planar members prevents angular motion of the hinge by supplying a resisting torque via the C-shaped body of the locking mechanism against any torques between the plurality of planar members and the associated hinge caused by a load force pulling toward the ground by gravity, thus placing the associated hinge in a locked state, or in other words, an engaged state.

In FIG. 6, locking mechanisms 113a and 113b are positioned in a disengaged state by being positioned on an associated planar member without encapsulating a hinge, thus allowing corresponding hinges to freely pivot. In one embodiment, locking mechanisms 113a and 113b have guiding rails that prevent removal of the locking mechanisms from a corresponding plurality of planar members. A guiding rail is a track that limits the motion of a corresponding locking mechanism to a disengaged state and an engaged state (i.e., unlocked and an unlocked states) along a corresponding planar member. There is a preferable safety advantage to have the guiding rail and locking mechanism positioned on a planar member closest to the tailgate as any slippage of the locking mechanism caused by gravity will tend to pull the locking mechanism into an engaged state. For example, a guiding rail integrated with planar member 109a restricts locking mechanism 113a between a disengaged state and an engaged state. During the disengaged state, the locking mechanism is positioned at a first end of planar member 109a (as shown in FIG. 6). Any slippage caused by gravity and/or transient vibrations of the ramp system will tend to pull locking mechanism 113a to an engaged state, wherein the locking mechanism encapsulates hinge 111a and portions of planar member 109a and planar member 109b (e.g., FIG. 7, wherein hinge 111a is covered by locking mechanism 113a).

In an alternate embodiment, locking mechanisms 113a and 113b can be entirely removed from the ramp assembly to allow respective hinges to be in a disengaged state and therefore free to pivot. To place the hinges in an engaged state, a user may slip locking mechanisms 113a and 113b over respective hinges 111a and 111c, therefore locking the respective hinges.

In FIG. 7, a perspective view of ramp system 100 having a hinge locking mechanism while in an engaged state is depicted. In this embodiment, locking mechanisms 111a and 113b encapsulate respective hinges 111a and 111c as well as respective portions of associated planar members in order to prevent angular motion of hinges 111a and 111c. In one embodiment, one locking mechanism locks a plurality of planar members, wherein the one locking mechanism is positioned on one of either sides of the plurality of planar members (e.g., one locking mechanism 113a locks planar member 109a and planar member 109b). In another embodiment, two locking mechanisms lock a plurality of planar members, wherein each of the two locking mechanisms are positioned on opposing sides of the plurality of planar members (e.g., a first locking mechanism 113a on a first side of members 109a and 109b, and second locking mechanism 113 on a second side of members 109a and 109b, such as shown in FIG. 7).

In a further embodiment, a locking mechanism, similar in form and function as locking mechanism 113a and 113b, is positioned to encapsulate a hinge that is configured to not buckle as a result of gravity while ramp system 100 is in an extended position. For example, a locking mechanism is positioned corresponding to hinge 111b (i.e., a hinge that does not buckle towards the ground) in same form and fashion as locking mechanism 113a respective to hinge 111a. In this embodiment, the additional locking mechanism adds further structural support to reduce structural strain on hinge 111b by transferring torques away from hinge 111b and to the planar members 109b and 109c.

In even further embodiments, any number of locking mechanisms are utilized in conjunction with any number of planar members and corresponding hinges.

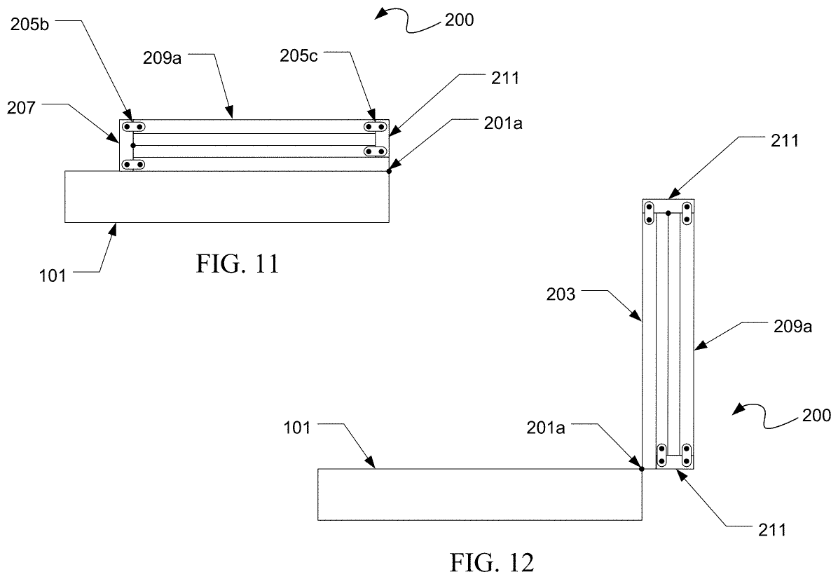

Referring now to FIGS. 8-12, an embodiment of ramp system 200 is depicted in various positions. In these figures, FIG. 9 and FIG. 11 illustrate ramp system 200 in an extended position and a storage position respectively. FIGS. 8, 10, and 12 are intermediate positions of ramp system 200 in passing between the extended position and the storage position. While FIGS. 8, 10, and 12 illustrate only some of the positions in passing between the extended position and the storage position, ramp system 200 may undergo any multitude of positions in passing between the extended position and the storage position based upon the geometrical and functional limitations of the components of ramp system 200 that are further described below.

FIG. 8 illustrates a side view of ramp system 200 demonstrating a range of motion. In this figure, ramp system 200 comprises a plurality of planar members 203 and 209a-c, intermediate planar member 207, intermediate planar member 211, a plurality of hinges (i.e., hinges 201a-b and hinges 205a-d). In this embodiment, ramp system 200 is integrated with a pickup truck by a hinge mounting between tailgate 101 and planar member 203 via hinge 201a.

FIG. 9 illustrates a side view of ramp system 200 in an extended position. During the extended position, ramp system 200 forms a ramp between tailgate 101 and ground 110, thus allowing a user to utilize ramp system 200 as a ramp in moving cargo from ground 110 into a truck bed via tailgate 101. Planar member 203, planar members 209a-c, intermediate planar member 207, and intermediate planar member 211 in conjunction with the plurality of hinges transfer structural loads to ground 110 and tailgate 101.

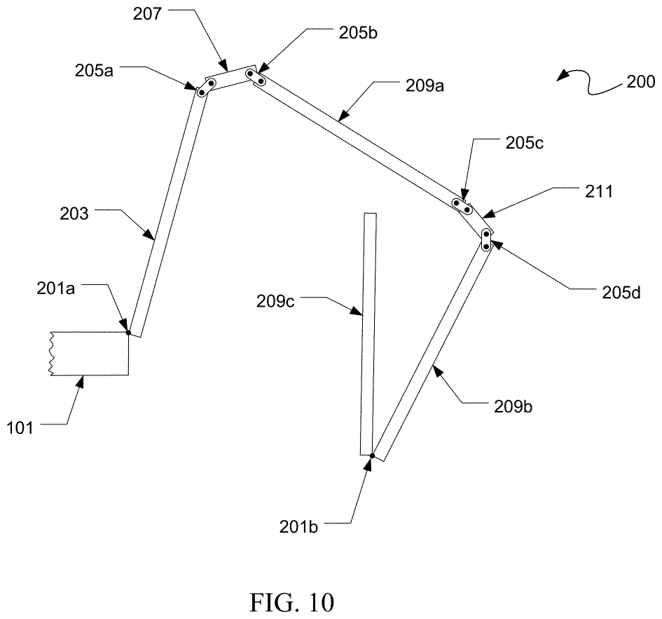

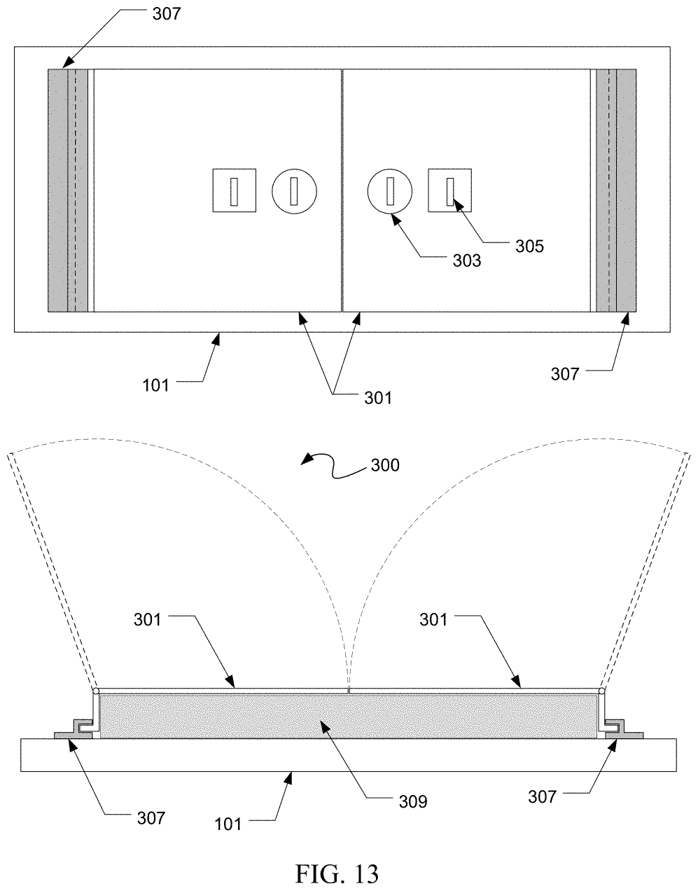

FIG. 10 illustrates a side view of ramp system 200 demonstrating a coil configuration. In this figure, ramp system 200 is in an intermediate position between being in a storage position and an extended position in order to illustrate a coil configuration feature. In a process of engaging ramp system 200 from a storage position to an engaged position, a user unfolds ramp system 200 from a storage position illustrated in FIG. 11 to a position illustrated in FIG. 12 by pivoting the ramp system assembly about hinge 201a. The user then uncoils ramp system 200 from a position illustrated in FIG. 12 to a position illustrated in FIG. 10, then to a position illustrated in FIG. 8, to finally an engaged position illustrated in FIG. 9. In a process of storing ramp system 200 from an engaged position to a storage position, the same process above is performed but in reverse order: a user coils ramps system 200 from the engaged position of FIG. 9, to the position of FIG. 8, then to the position of FIG. 10, and then to the position of FIG. 12. The user then folds ramp system 200 from the position illustrated in FIG. 12 to the storage position of FIG. 11 by pivoting the ramp system assembly about hinge 201a.

FIG. 11 illustrates a side view of ramp system 200 in a storage position. During the storage position, ramp system 200 is in a compact configuration thus permitting ramp system 200 to be easily transported while attached to tailgate 101.

FIG. 12 is a side view of ramp system 200 expanding from the storage position to a first position that allows the ramp system to expand into the extended position.

Tailgate 101 is a conventional tailgate generally associated with pickup trucks. Hinges 205a-d are dual hinge devices of similar form and function as hinge 103 of ramp system 100. The assembly between member 203, hinge 205a, and intermediate member 207 is such that the combined pivotal angle between member 203 and intermediate member 207 is at least 90 degrees. Similarly for hinge 205b, the combined pivotal angle between intermediate member 207 and member 209a is at least 90 degrees; for hinge 205c, the combined pivotal angle between member 209a and intermediate member 211 is at least 90 degrees; and for hinge 205d, the combined pivotal angle between intermediate member 211 and member 209b is at least 90 degrees. Various types of hinges that allow the at least 90 degrees of angular range of motion for 205a-d are contemplated. In alternate embodiments, hinges 205a-d allow for a full range of motion wherein the realized angular range of motion of the system is dependent on a geometrical configuration between corresponding members connected to each respective hinge.

Hinges 201a-b are configured to allow a 180 degree angular motion. In an alternate embodiment, a range of angular motion of hinges 201a-b is limited by mating geometry of respective planar members. For example, in an extended position (FIG. 9), hinge 201b is positioned to allow member 209b and member 209c to pivot with respect to each other, but angular motion is limited by a mating of respective ends of member 209b and member 209c. Furthermore, hinge 201a is positioned to allow member 203 to pivot with respect to tailgate 101, but angular motion is limited by a mating of respective ends of member 203 and tailgate 101. Conversely, in a storage position (FIG. 11), hinge 201a allows member 203 and tailgate 101 to planarly mate, and, in similar form and function, hinge 201b allows member 209b and member 209c to planarly mate.

Planar members 209a-c are of similar form and function as planar members 109a-d. Intermediate planar member 207 has a length corresponding to a combined height of planarly stacked planar members 209a-c and member 203 (see FIG. 11). Intermediate planar member 211 has a length corresponding to a combined height of planarly stacked planar members 209a-c.

In one embodiment, a plurality of planar members, a plurality of intermediate planar members, and a plurality of hinges are interconnected and configured to form a ramp, wherein the configuration allow for the ramp assembly to collapse in a “coil” pattern, such as the configuration of FIG. 11.

In one embodiment, a plurality of C-shaped locking mechanisms depicted in FIG. 6 and FIG. 7 are used to add additional structural support to ramp system 200 by encapsulating a respective hinge and a portion of a planar member. In this embodiment, a c-shaped locking mechanism can be used in conjunction with hinges 205a-d and hinge 201b. For example, a locking mechanism is positioned to encapsulate hinge 205a and a portion of member 203 and intermediate member 207, thus preventing hinge 205a from pivoting while also adding additional structural support to hinge 205a. In an alternate embodiment, a locking mechanism has a corresponding length that encapsulates two hinges. For example, a C-shaped locking mechanism encapsulates hinge 205a, hinge 205b (and subsequently the side of intermediate member 207), and a portion of member 203 and member 209a, thus preventing hinge 205a and hinge 205b from pivoting while also adding additional structural support to the said hinges.

Referring now to FIG. 13, storage cabinet 300 that houses ramp system 309 is depicted in various views. In this figure, a top view and a front view of storage cabinet 300 is shown. In this embodiment, storage cabinet 300 is mounted on tailgate 101. Storage cabinet 300 comprises a set of rack mounts 307 and a set of cabinet doors 301, wherein the set of cabinet doors further comprise lock 303 and handle 305. The set of rack mounts 307 are mounted to tailgate 101 using either bolt fasteners, rivets, welding, or any fastening method known in the art. The set of rack mounts 307 have a channel groove that permits a set of cabinet doors 301 to slide along the channel groove (i.e., a tongue and groove configuration) into the position shown in FIG. 13. Various methods of securing the set of cabinet doors 310 to the set of rack mounts 307 are contemplated. Each door of the cabinet doors 301 comprise of a foundational member that has a tongue (as part of the tongue and groove system of mating cabinet doors 301 to rack mounts 307), a door, and a hinge that connects the foundational member to the door that permits the door to pivot with respect to the foundational member.

In this embodiment, storage cabinet 300 houses ramp system 309 (i.e., ramp system 100 or ramp system 200) while ramp system 309 is in a storage position. While the ramp system is in a storage position, the doors of storage cabinet 300 are closed, thus encapsulating and securing ramp system 309. In transforming ramp system 309 from a storage position to an engaged position, a user unlocks storage cabinet 300 via lock 303 and pulls on handle 305 to open an associated door of cabinet doors 301 in order to splay the set of doors of cabinet doors 301 away from tailgate 100, thus exposing ramp system 309. While the set of doors of cabinet doors 301 are open, the user can unfold (or uncoil) ramp system 309 into an engaged position.

In one embodiment, ramp system 309 is attached to the foundational member. For example, for ramp system 100, the ramp system is attached to the foundational member via hinge 103; and for ramp system 200, the ramp system is attached to the foundational member via hinge 201a. In this embodiment, cabinet doors 301 attached ramp system 309 are removable via the tongue and groove system of the mating cabinet doors 301 to rack mounts 307.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A collapsible ramp system, comprising:
a plurality of planar members;
an intermediate planar member;
a first hinge, wherein the first hinge is a dual hinge that permits an angular range of at least zero to 90 degrees;
a second hinge, wherein the second hinge is a dual hinge that permits an angular range of at least zero to 180 degrees; and
a plurality of a third hinge, wherein each hinge of the plurality of the third hinge permits an angular range of 180 degrees;
wherein the plurality of planar members and the plurality of the third hinge form an assembly, wherein the assembly is configured to permit a zig-zag collapsing pattern;
wherein the plurality of planar members and the plurality of the third hinge of the assembly are configured to permit the plurality of planar members to straighten to form a ramp; and
wherein a first end of the intermediate planar member is connected to a first end of the assembly of the plurality of planar members and the plurality of the third hinge by the second hinge.

2. The system of claim 1, wherein the assembly comprises four planar members and three of the third hinge.

3. The system of claim 1, further comprising:
a first plurality of C-shaped locking mechanisms that encapsulate a corresponding first set of hinges among the plurality of the third hinge, wherein the first plurality of C-shaped locking mechanisms prevent the corresponding first set of hinges among the plurality of the third hinge from buckling towards a ground as a result of the zig-zag collapsing pattern.

4. The system of claim 3, further comprising:
a second plurality of C-shaped locking mechanisms that encapsulate a corresponding second set of hinges among the plurality of the third hinge, wherein the second set of hinges among the plurality of the third hinge do not buckle towards the ground as a result of the zig-zag collapsing pattern, and wherein corresponding second plurality of C-shaped locking mechanisms provide additional structural support to the assembly.

5. The system of claim 3, further comprising guiding rails along the plurality of planar members corresponding to the first plurality of C-shaped locking mechanisms, wherein the guiding rails prevent removal of the plurality of locking mechanism from the corresponding plurality of planar members.

6. The system of claim 5, further comprising guiding rails along the corresponding plurality of planar members positioned at a respective first end of each planar member of the plurality of planar members such that any slippage of the C-shaped locking mechanism caused by gravity while will pull the C-shaped locking mechanism into an engaged state.

7. The system of claim 1, wherein the second end of the intermediate planar member is connected to a tailgate via the first hinge.

8. The system of claim 1, further comprising:
a cabinet door assembly that houses the collapsible ramp during storage, wherein the cabinet door assembly comprises:
a set of rack mounts having a groove as part of a tongue and groove configuration, wherein the set of rack mounts are mounted on a tailgate; and
a set of door assemblies, wherein a door assembly among the set of door assemblies comprises a foundational member that has a tongue as part of the tongue and groove configuration, a door, and a hinge that connects the foundational member to the door that permits the door to pivot with respect to the foundational member.

9. The system of claim 8, wherein the second end of the intermediate planar member is connected to the foundational member of the cabinet door assembly.

10. A collapsible ramp system, comprising:
a plurality of planar members;
a first intermediate planar member;
a second intermediate planar member;
a plurality of a first-type hinge, wherein the first-type hinge is a dual hinge that permits an angular range of at least 90 degrees; and
a plurality of a second-type hinge, wherein each hinge of the plurality of the second-type hinge permits an angular range of at least 180 degrees;
wherein a first planar member is connected to a second planar member via a first of the second-type hinge, the second planar member is connected to the first intermediate planar member via a first of the first-type hinge, the first intermediate planar member is connected to the third planar member via a second of the first-type hinge, the third planar member is connected to the second intermediate planar member via a third of the first-type hinge, and the second intermediate planar member is connected to a fourth planar member via a fourth of the first-type hinge;
wherein the first planar member, the second planar member, the third planar member, the first intermediate planar member, and the second intermediate planar member form an assembly, wherein the assembly is configured to permit a coil collapsing pattern via corresponding interconnected hinges; and
wherein the assembly is configured to permit the first planar member, the second planar member, the third planar member, the first intermediate planar member, and the second intermediate planar member to straighten to form a ramp via the corresponding interconnected hinges;

11. The system of claim 10, further comprising:
a plurality of C-shaped locking mechanisms that encapsulate each hinge of the assembly to provide additional structural support to the assembly.

12. The system of claim 11, further comprising guiding rails along the plurality of planar members corresponding to the plurality of C-shaped locking mechanisms, wherein the guiding rails prevent removal of the plurality of locking mechanism from the corresponding plurality of planar members.

13. The system of claim 10, wherein the fourth planar member is connected to a tailgate via a second of a second-type hinge.

14. The system of claim 10, further comprising:
a cabinet door assembly that houses the collapsible ramp during storage, wherein the cabinet door assembly comprises:
a set of rack mounts having a groove as part of a tongue and groove configuration, wherein the set of rack mounts are mounted on a tailgate;
a set of door assemblies, wherein a door assembly among the set of door assemblies comprises a foundational member that has a tongue as part of the tongue and groove configuration, a door, and a hinge that connects the foundational member to the door that permits the door to pivot with respect to the foundational member.

15. The system of claim 14, wherein the second end of the intermediate planar member connected to the foundational member of the cabinet door assembly.

16. A method of operating a ramp system, comprising:
pivoting the ramp system away from a tailgate via a hinge connecting a first end of the ramp system; and
unfolding the ramp system via a plurality of hinges such that a second end of the ramp system makes contact with a ground.

17. The method of operating the ramp system of claim 16, wherein unfolding the ramp system is based on a zig-zag configuration of unfolding the ramp system.

18. The method of operating the ramp system of claim 17, further comprising:
positioning a plurality of C-shaped locking mechanisms corresponding to a plurality of hinges, wherein the positioning of a corresponding C-shaped locking mechanism encapsulates a corresponding hinge and a portion of a set of planar members such that the C-shaped locking mechanism prevents the hinge from pivoting with respect to the set of planar members.

19. The method of operating the ramp system of claim 16, wherein unfolding the ramp system is based on a coil configuration of unfolding the ramp system.

20. The method of operating the ramp system of claim 19, further comprising:
positioning a plurality of C-shaped locking mechanisms corresponding to a plurality of hinges, wherein the positioning of a corresponding C-shaped locking mechanism encapsulates a corresponding hinge and a portion of a set of planar members such that the C-shaped locking mechanism adds further structural support to the hinge with respect to the set of planar members.
